(19) United States
(12) Patent Application Publication
(10) Pub. No.: US 2025/0358603 A1
(43) Pub. Date: Nov. 20, 2025

(54) ROAM STATUS INDICATION FOR WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/196,654

(22) Filed: May 1, 2025

Related U.S. Application Data
(60) Provisional application No. 63/649,103, filed on May 17, 2024.

(51) Int. Cl. H04W 8/02

(52) U.S. Cl. CPC H04W 8/02

(57) ABSTRACT

An embodiment includes a station (STA) may transmit an intent to roam to one or more target APs to a current AP associated with the STA and the current AP may communicate with the one or more target APs to determine whether or not the target APs can accommodate the roam request and various traffic and QoS requirements of the STA, and the current AP can provide the status information to the STA such that once the STA determines a need to roam, it can successfully roam to target APs that are willing and able to accommodate the STAs roaming request, thereby minimizing failed roaming attempts.

### CROSS-REFERENCE TO RELATED APPLICATION(S)

This application claims the benefit of priority from U.S. Provisional Application No. 63/649,103, entitled “ROAM FAILURE INDICATION FOR NEXT GENERATION NETWORKS” filed May 17, 2024, which is incorporated herein by reference in its entirety.

### TECHNICAL FIELD

This disclosure relates generally to a wireless communication system, and more particularly to, for example, but not limited to, roam status indication in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure a station (STA) in a wireless network, the STA comprising: a memory; and a processor coupled to the memory. The processor is configured to transmit, to an access point (AP) associated with the STA, a first frame indicating one or more target APs for an upcoming roaming, wherein the AP and the one or more target APs are in a first seamless mobility domain where the AP and the one or more target APs coordinate with one another. The processor is configured to receive, from the AP, a second frame including status information associated with the one or more target APs, the status information indicating whether the one or more target APs are prepared for the upcoming roaming. The processor is configured to transition from the AP to a target AP based on the status information.

In some embodiments, to transition from the AP to the target AP, the processor is configured to: determine that at least one target AP among the one or more target APs is prepared for the upcoming roaming based on the status information; and transition from the AP to the at least one target AP among the one or more target APs.

In some embodiments, to transition from the AP to the target AP, the processor is configured to: determine that no target AP among the one or more target APs is prepared for the upcoming roaming based on the status information; and transition from the AP to the target AP (i) that is in a second seamless mobility domain (ii) that is in the first seamless mobility domain and is not among the one or more target APs, or (iii) that is not associated with a seamless mobility domain.

In some embodiments, the processor is further configured to: determine that no target AP among the one or more target APs is prepared for the upcoming roaming; and transmit, to the AP, a third frame, wherein the third frame indicates one or more target APs for the upcoming roaming.

In some embodiments, the second frame includes one or more of: i) a list of one or more target APs that are prepared for the upcoming roaming, ii) a list of one or more target APs that are not prepared for the upcoming roaming, iii) a time period that the STA has to wait before performing another roaming attempt or iv) one or more status codes providing status information for the one or more target APs regarding the upcoming roaming.

In some embodiments, the STA of claim 1, wherein the second frame indicates a time deadline for the STA to transition to the target AP.

In some embodiments, the processor is further configured to: receive, from the AP, a third frame that includes update status information associated with the one or more target APs; and determine whether to roam to a target AP from the one or more target APs based on the updated status information.

One aspect of the present disclosure provides an access point (AP) in a wireless network, the AP comprising: a memory; and a processor coupled to the memory. The processor is configured to receive, from a station (STA) associated with AP, a first frame indicating one or more target APs for an upcoming roaming, wherein the AP and the one or more target APs are in a first seamless mobility domain where the AP and the one or more target APs coordinate with one another. The processor is configured to transmit, to the STA, a second frame including status information associated with the one or more target APs, the status information indicating whether the one or more target APs are prepared for the upcoming roaming.

In some embodiments, at least one target AP among the one or more target APs is prepared for the upcoming roaming based on the status information, and the processor is configured to communicate with the at least one target AP among the one or more target APs to transition the STA from the AP to the at least one target AP.

In some embodiments, no target AP among the one or more target APs is prepared for the upcoming roaming, and the processor is configured to: receive, from the STA, a third frame, wherein the third frame indicates one or more target APs for the upcoming roaming.

In some embodiments, the second frame includes one or more of: i) a list of one or more target APs that are prepared for the upcoming roaming, ii) a list of one or more target APs that are not prepared for the upcoming roaming, iii) a time period that the STA has to wait before performing another roaming attempt or iv) more status codes providing status information for the one or more target APs regarding the upcoming roaming.

In some embodiments, the second frame indicates a time deadline for the STA to transition to the target AP.

In some embodiments, the processor is further configured to transmit, to the STA, a third frame that includes update status information associated with the one or more target APs.

One aspect of the present disclosure provides a computer-implemented method for communication by a station (STA) in a wireless network. The method comprises transmitting, to an access point (AP) associated with the STA, a first frame indicating one or more target APs for an upcoming roaming, wherein the AP and the one or more target APs are in a first seamless mobility domain where the AP and the one or more target APs coordinate with one another. The method comprises receiving, from the AP, a second frame including status information associated with the one or more target APs, the status information indicating whether the one or more target APs are prepared for the upcoming roaming. The method comprises transitioning from the AP to a target AP based on the status information.

In some embodiments, the method further comprises, to transition from the AP to the target AP: determining that at least one target AP among the one or more target APs is prepared for the upcoming roaming based on the status information; and transitioning from the AP to the at least one target AP among the one or more target APs.

In some embodiments, the method further comprises, to transition from the AP to the target AP: determining that no target AP among the one or more target APs is prepared for the upcoming roaming based on the status information; and transitioning from the AP to the target AP (i) that is in a second seamless mobility domain (ii) that is in the first seamless mobility domain and is not in the one or more target APs, or (iii) that is not associated with a seamless mobility domain.

In some embodiments, the method further comprises, determining that no target AP among the one or more target APs is prepared for the upcoming roaming; and transmitting, to the AP, a third frame, wherein the third frame indicates one or more target APs for the upcoming roaming.

In some embodiments, the method further comprises, the second frame includes one or more of: i) a list of one or more target APs that are prepared for the upcoming roaming, ii) a list of one or more target APs that are not prepared for the upcoming roaming, iii) a time period that the STA has to wait before performing another roaming attempt or iv) one or more status codes providing status information for the one or more target APs regarding the upcoming roaming.

In some embodiments, the method further comprises, the second frame indicates a time deadline for the STA to transition to the target AP.

In some embodiments, the method further comprises, receiving, from the AP, a third frame that includes update status information associated with the one or more target APs; and determining whether to roam to a target AP from the one or more target APs based on the updated status information.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates stages of a mobility handover procedure in accordance with an embodiment.

FIG. 5 illustrates a flow chart of an example process by a current AP for providing a roaming status in accordance with an embodiment.

FIG. 6 illustrates a flow chart of an example process by an STA for receiving a roaming status in accordance with an embodiment.

FIG. 7 illustrates a flow chart of an example process by an STA for receiving a roaming status with no successful target AP setups in accordance with an embodiment.

FIG. 8 illustrates a flow chart of an example process by a target AP of providing a status update in accordance with an embodiment.

FIG. 9 illustrates a flow chart of an example process by a current AP of providing a status update in accordance with an embodiment.

FIG. 10 illustrates a flow chart of an example process by a STA of receiving a status update in accordance with an embodiment.

FIG. 11 illustrates an example timeline of a roaming preparation in accordance with an embodiment.

FIG. 12 illustrates an example timeline of a roaming preparation in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter

As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

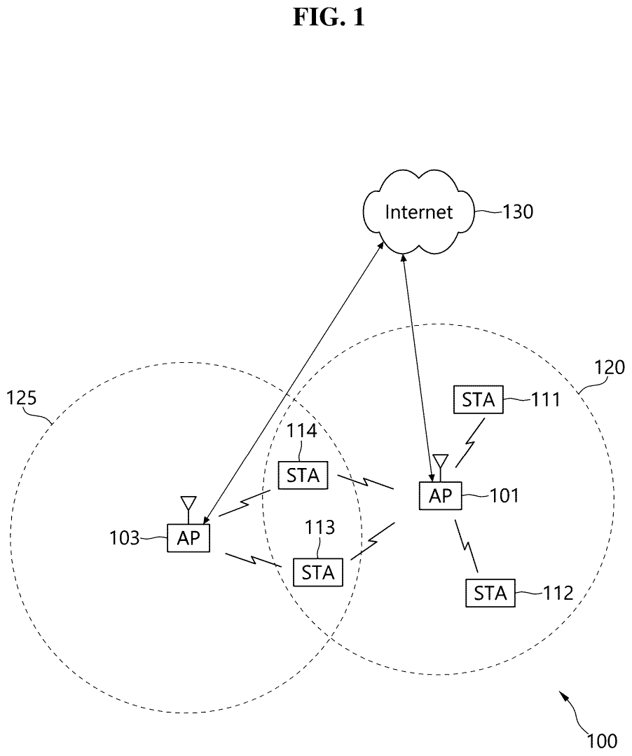

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

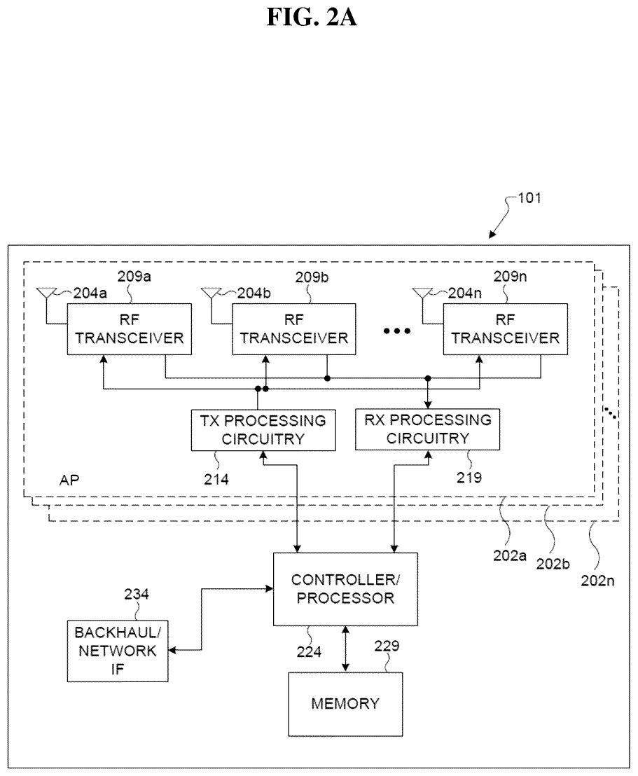

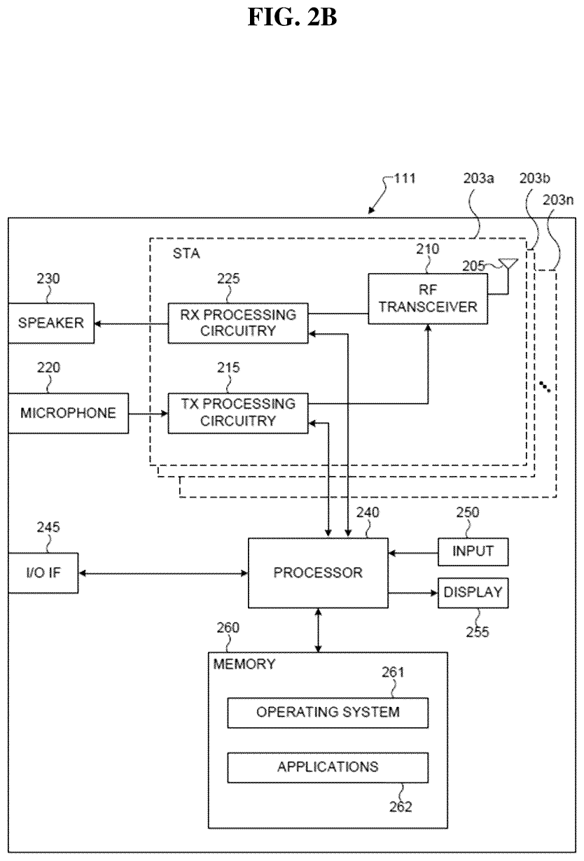

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

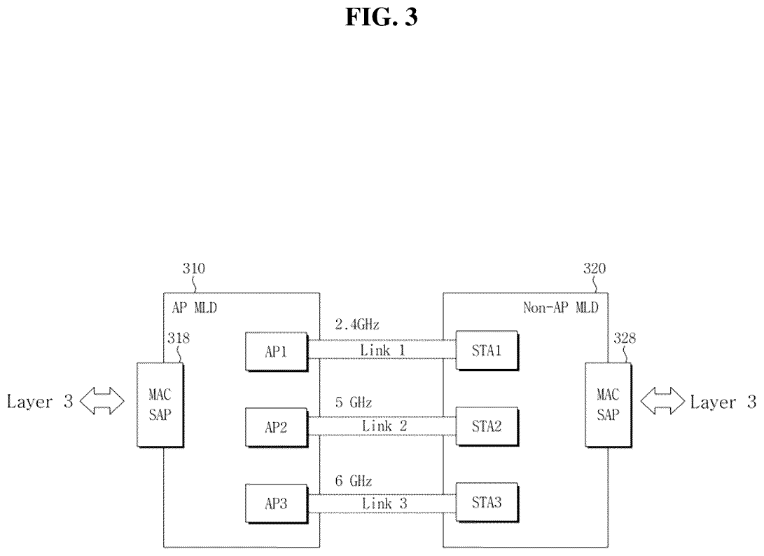

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11bc/D5.0, “Wireless LAN Medium Access Control (MAC) and Physical Layer (PHY) Specifications.

As users move around an environment while holding a STA device, a signal strength of the STA to its connected AP can vary. If a user's movement causes a significant decrease in a signal strength, a handover may be necessary. During the handover process, an STA may switch from an associated AP, which may be referred to herein as current AP (CAP), to a new AP.

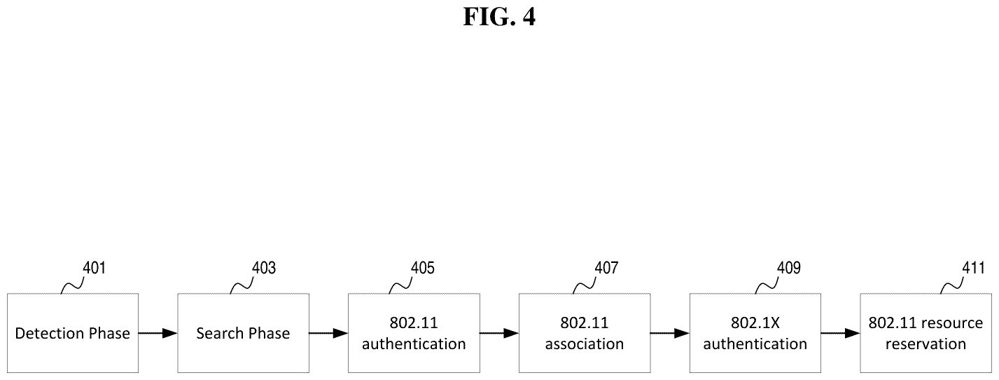

FIG. 4 illustrates stages of a mobility handover procedure in accordance with an embodiment. As shown in FIG. 4, in legacy devices without any mobility support, the handover procedure may involve several steps, including a detection phase 401, a search phase 403, an 802.11 authentication phase 405, an 802.11 association phase 407, an 802.1X authentication phase 409, and an 802.11 resource reservation phase 411.

During the detection phase 401, an STA may determine that there is a need for a handover. The procedures to detect a need for handover may be vendor specific. For instance, a particular vendor implementation may choose to trigger a handover when the signal strength to the currently associated AP drops below a certain threshold.

The detection phase 401 may be followed by a search phase 403. During the search phase 403, the STA may search for new APs to associate with. During the search phase 403, the STA may perform a scan of different channels to identify APs in the vicinity. This can be done either passively (e.g., listening to beacons on a particular channel) or actively (e.g., by the use of probe request and response procedure).

After the scanning procedure is complete, the next step is to perform 802.11 authentication (open system/shared key based) 405. Once the STA is authenticated, the next step is to perform 802.11 association 807. Introduced in IEEE 802.11i amendment, the 802.1X authentication phase 409 may include an EAP authentication between the STA and a AAA server with the assistance of the AP. Finally, during the 802.11 resource reservation phase 411, the STA may set up various resources at the new AP. For example, the STA can perform quality of service (QoS) reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In next generation wireless network, a number of APs can coordinate with each other to form a seamless mobility domain. With a seamless mobility domain, roaming from one AP to another AP can be done seamlessly by a STA (e.g., without requiring (Re) association). In some embodiments, the STA may indicate to the STA's current AP the candidate APs that the STA may intend to roam to. The current AP may then coordinate with the candidate APs to ensure a seamless roam for the STA (e.g., preparing potential target AP(s) for the roam). In particular, when the STA detects a need to roam, the STA can inform the current AP about which target AP the STA intends to roam to and the current AP may transfer a remaining context to the target AP, upon which the STA may roam to the target AP.

However, it may be possible that during an initial roam request, the target AP(s) selected by the STA may not be able to handle the STA's contexts (e.g., QoS requirements, among other requirements) due to a number of reasons. For example, a target AP may not be able to handle an STA's contexts due to a traffic overload, a QoS requirement violation of the AP's own STAs, among other factors. Accordingly, embodiments in accordance with this disclosure provide signaling and behavior that can enable a current AP to inform the STA about a target AP's capacity to accommodate roaming and/or whether the target AP can handle the STA's context (e.g., QoS requirements, among other requirements).

In some embodiments, during a roam preparation phase, the current AP may attempt to prepare potential target APs and determine whether the target APs are willing and able to associate with an STA during roaming (e.g., accommodate roaming for the STA from the current AP to the target AP). However, if the target APs are not willing or unable to accommodate an STA for roaming, they can provide such an indication to the current AP. In some embodiments, the current AP may then inform the STA about the target AP(s)'s response to the roaming preparation attempt. In some embodiments, the current AP can transmit a status message to the STA that can include at least one or more of the information items as indicated in Table 1.

Table 1 provides information items that can be present in a status message in accordance with an embodiment.

TABLE 1

| Information | |
|---|---|
| item | Description |
| Prepared AP | An information item that can indicate the list of target APs that can be |
| list | prepared for the roam. e.g., AP's BSSID list. In some embodiments, if none |
| | of the indicated APs can be prepared for a roam, this list can be a null list. |
| | Reception of a null list can indicate to the STA that none of the APs may be |
| | prepared. |
| Failed AP list | An information item that can indicate the list of APs that cannot be |
| | prepared for the roam. e.g., AP's BSSID list. |
| Status | An information item that can indicate the status of the roam preparation for |
| information | one or more of the target APs. e.g., status code. The status code can also be |
| | provided for each of the target APs and can indicate a status of the target |
| | AP (e.g., prepared, not prepared, among others). |
| Reason | An information item that can indicate the reason for the preparation status |
| information | of different target APs. e.g., reason code. In some embodiments, the current |
| | AP can provide an explanation of why some of the target APs cannot be |
| | prepared for roam. e.g., due to QoS requirements not being satisfied. This |
| | can then enable the STA to make modified preparation requests to the |
| | current AP. |
| STA | An information item that can guide the STA one what actions it can take. |
| guidance | e.g., a code that can indicate to the STA to make another request at a later |
| | point in time, a code that can indicate to the STA to choose an AP from |
| | another domain, among others. |
| Re-attempt | An information item that can indicate the time after which the STA can |
| timing | make another attempt for setup. e.g., the number of target beacon transmit |
| indication | times (TBTTs) from the current TBTT. |

When a STA receives the above status information provided in Table 1, the STA can attempt to roam to a target AP in the prepared AP list at a future time. If none of the target APs are prepared, based on the reason information, the STA can make another request at a later point in time or can choose to roam to a different domain if a target AP exists in such a domain.

In some embodiments, the STA may attempt to make a brute force roam attempt with a target AP based on the baseline roaming procedure illustrated in FIG. 4, which may include the STA performing a detection phase, a search phase, an 802.11 authentication phase, an 802.11 association phase, an 802.1X authentication phase 409, and a 802.11 resource reservation phase 411. In some embodiments, instead of roaming through its current AP, the STA can directly communicate with the target AP(s) at a later point in time.

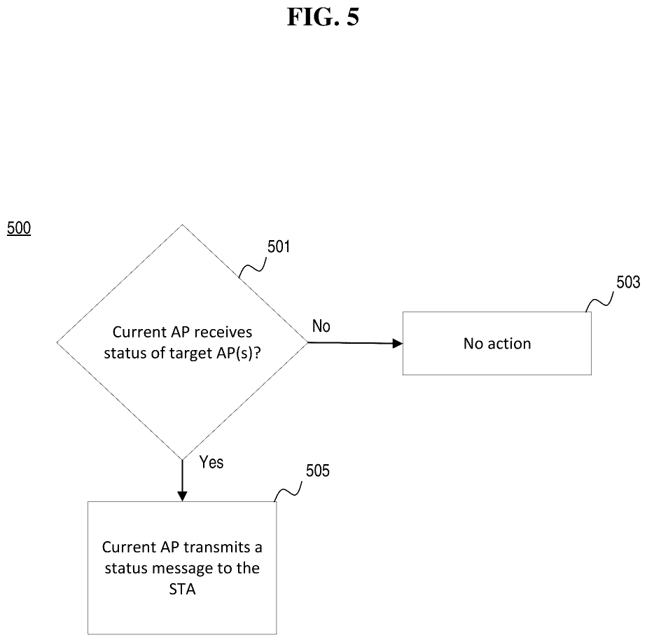

FIG. 5 illustrates a flow chart of an example process by a current AP for providing a roaming status in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 5 illustrates operations performed in a AP, such as the AP illustrated in FIG. 3.

The process 500, in operation 501, the current AP determines whether the current AP receives a status of one or more target AP(s). In some embodiments, a status may indicate whether the one or more target APs are willing and able to accommodate or not a roaming request for a particular STA.

If the current AP determines that it does not receive a status, the process proceeds to operation 503 where the current AP performs no action. If the current AP determines that it does receive a status, the process proceeds to operation 505.

In operation 505, the current AP transmits to the STA a status message. In some embodiments, the status message may include one or more of the information items in Table 1, including a prepared AP list, a failed AP list, status information, reason information, STA guidance information, or re-attempt timing indication information. The prepared AP list may include an information item that can indicate the list of target APs that can be prepared for the roam. e.g., AP's BSSID list. The failed AP list may include an information item that can indicate the list of APs that cannot be prepared for the roam. e.g., AP's BSSID list. The status information may include an information item that can indicate the status of the roam preparation for one or more of the target APs. The reason information may include an information item that can indicate the reason for the preparation status of different target APs. The STA guidance information may include an information item that can guide the STA one what actions it can take in order to roam. The re-attempt timing indication may include an information item that can indicate the time after which the STA can make another attempt for setup.

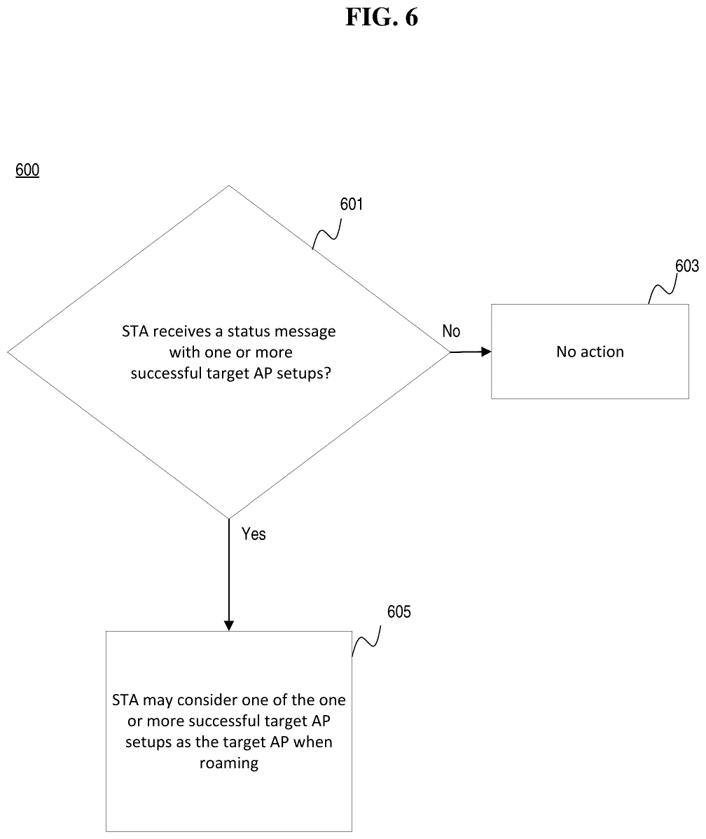

FIG. 6 illustrates a flow chart of an example process by an STA for receiving a roaming status in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 6 illustrates operations performed in a STA, such as the STA illustrated in FIG. 3.

The process 600, in operation 601, the STA determines whether the STA receives a status message with one or more successful target AP setups. If the STA determines that it does not receive a status message with one or more successful target AP setups, the process proceeds to operation 603 and the STA performs no action. If the STA determines that it does receive a status message with one or more successful target AP setups, the process proceeds to operation 605. In some embodiments, the status message may include one or more of the information items provided in Table 1.

In operation 605, the STA may consider one of the one or more successful target AP setups as the target AP when roaming. According, the STA may roam to a target AP in a list of prepared target APs at a future time.

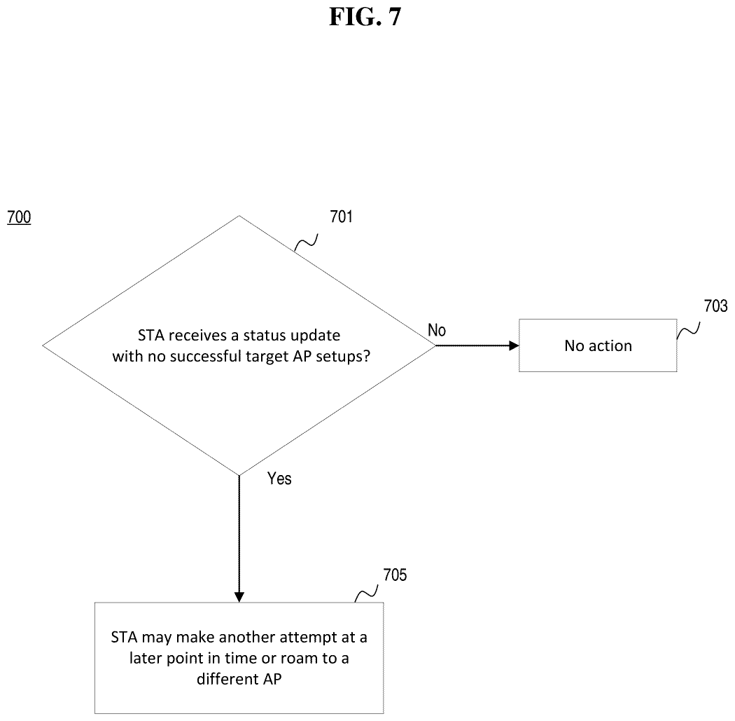

FIG. 7 illustrates a flow chart of an example process by an STA for receiving a roaming status with no successful target AP setups in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 7 illustrates operations performed in a STA, such as the STA illustrated in FIG. 3.

The process 700, in operation 701, the STA determines whether the STA receives a status message with no successful target AP setups. In some embodiments, the status message may include one or more of the information items provided in Table 1. If the STA determines that it does not receive a status message with no successful target AP setups, the process proceeds to operation 703 and the STA performs no action. If the STA determines that it does receive a status message with no successful target AP setups, the process proceeds to operation 705.

In operation 705, the STA may make another attempt at a later point in time or roam to a different AP. In some embodiments, the different AP may be in a different seamless roaming domain where the different AP may not coordinate with a current AP with which the STA is associated. In some embodiments, the STA may directly communicate with a target AP and use a brute force roaming technique to setup roaming with the target AP.

In some embodiments, one or more of the target AP(s) can update their status to the current AP at a later point in time. In some embodiments, the STA can also indicate during roaming preparation to the STA's current AP that the STA can receive the status update of the target AP(s) at a later point in time.

In some embodiments, the current AP may also indicate to the target AP(s) a time deadline until which an update can be provided. In particular, after the time deadline specified by the current AP during which an update may be provided, a received update may not be meaningful and/or useful for a STA.

In some embodiments, an STA may provide a current AP with a time deadline to roam and the current AP may repeatedly check with one or more target APs to determine their status (e.g., willing to accommodate roaming or unable to accommodate roaming) up until the indicated deadline to roam.

In some embodiments, the current AP may transmit an update to the STA in an update message. The update message can include at least one or more of the information items as indicated in Table 2.

Table 2 provides information items that can be present in an update message in accordance with an embodiment.

| Information | |
|---|---|
| items | Description |
| AP list | An information item that can indicate a list of APs |
| | for which there is an update. e.g., basic service |
| | set identifier (BSSID). |
| Status code | An information item that can indicate the updated status |
| | code of the APs. e.g., a status code indicating a status |
| | for one or more of the indicated APs. |
| Updated | An information item that can indicate the updated deadline |
| deadlines | for the STA to roam to the target AP. |

In some embodiments, the AP may also transmit another status message with one or more of the information items in Table 1 as an update message.

In some embodiments, upon receiving an update message, the STA may also consider one or more of the updated target AP(s) as candidate target APs that are available for the STA to roam to in the future.

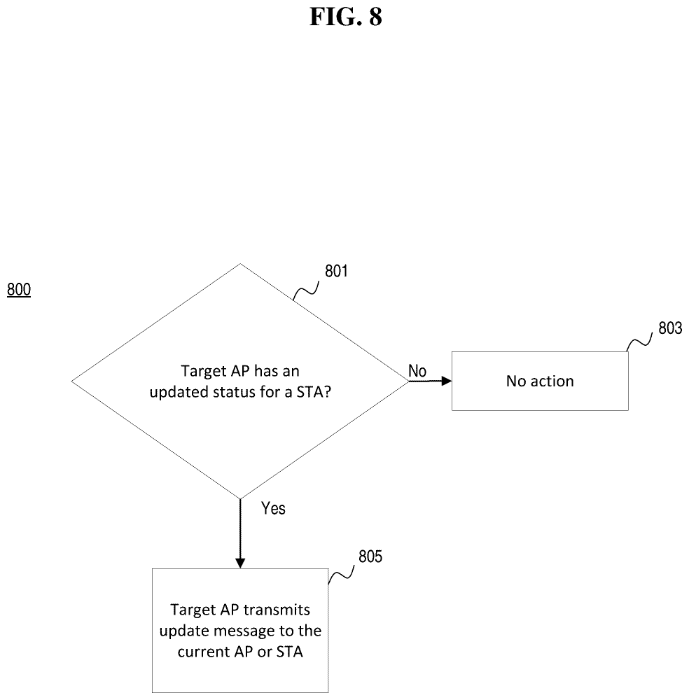

FIG. 8 illustrates a flow chart of an example process by a target AP of providing a status update in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 8 illustrates operations performed in a AP, such as the AP illustrated in FIG. 3.

The process 800, in operation 801, the target AP determines whether the target AP has an updated status for a STA. If the target AP determines that the target AP does not have an updated status for the STA, the process proceeds to operation 803 and the target AP performs no action. If the target AP determines that the target AP does have an updated status for the STA, the process proceeds to operation 805.

In operation 805, the target AP transmits an update message to the current AP or the STA. In some embodiments, the update message may include an information item that can indicate a list of APs for which there is an update. e.g., BSSID. In some embodiments, the update message may include an information item that can indicate the updated status code of the APs (e.g., a status code indicating a status for one or more of the target APs, including whether or not the target AP can accommodate a roaming). In some embodiments, the update message may include an information item that can indicate the updated deadline for the STA to roam to the target AP.

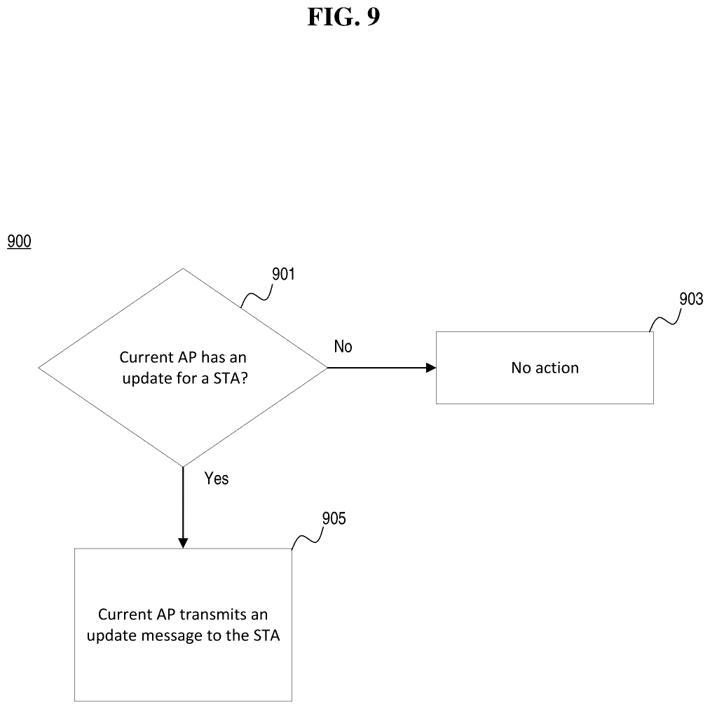

FIG. 9 illustrates a flow chart of an example process by a current AP of providing a status update in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 9 illustrates operations performed in a AP, such as the AP illustrated in FIG. 3.

The process 900, in operation 901, the current AP determines whether the current AP has an updated status for a STA. If the current AP determines that the current AP does not have an updated status for the STA, the process proceeds to operation 803 and the current AP performs no action. If the current AP determines that the current AP does have an updated status for the STA, the process proceeds to operation 805.

In operation 905, the current AP transmits an update message to the STA. In some embodiments, the update message may include one or more of the information items set forth in Table 2.

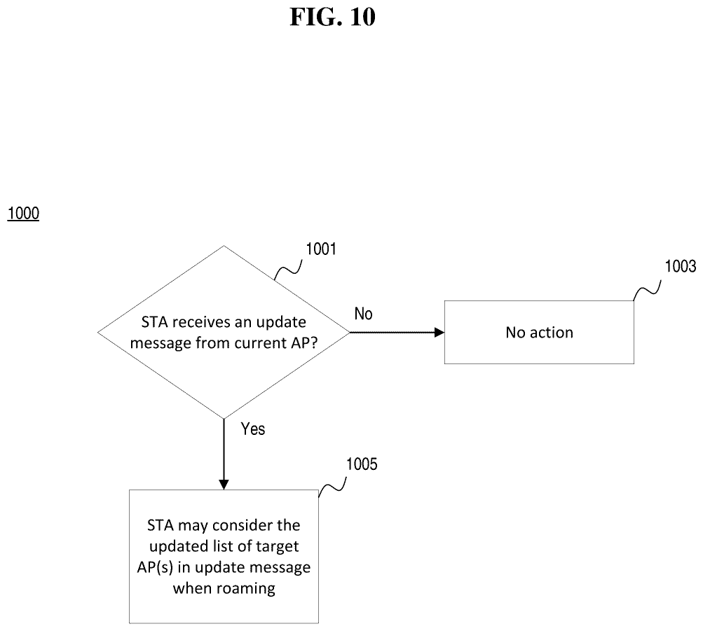

FIG. 10 illustrates a flow chart of an example process by a STA of receiving a status update in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 10 illustrates operations performed in a STA, such as the STA illustrated in FIG. 3.

The process 1000, in operation 1001, the STA determines whether the STA receives an update message from the current AP. If the STA determines that the STA has not received an update message from the current AP, the process proceeds to operation 1003 and the STA performs no action. If the STA determines that the STA has received an update message from the current AP, the process proceeds to operation 1005.

In operation 1005, the STA may consider the updated list of target APs included in update message when roaming. In some embodiments, the update message may include one or more of the information items set forth in Table 2.

In some embodiments, the STA can transmit a preparation request message to the current AP (CAP), where the preparation request message may indicate the target APs (TAP) that the STA intends to roam to. In some embodiments, the target APs may be in the same roaming domain as the current AP (e.g., via logical AP MLD, seamless mobility domain, among others). In some embodiments, upon receiving the preparation request message, the current AP may prepare the target APs for the roam.

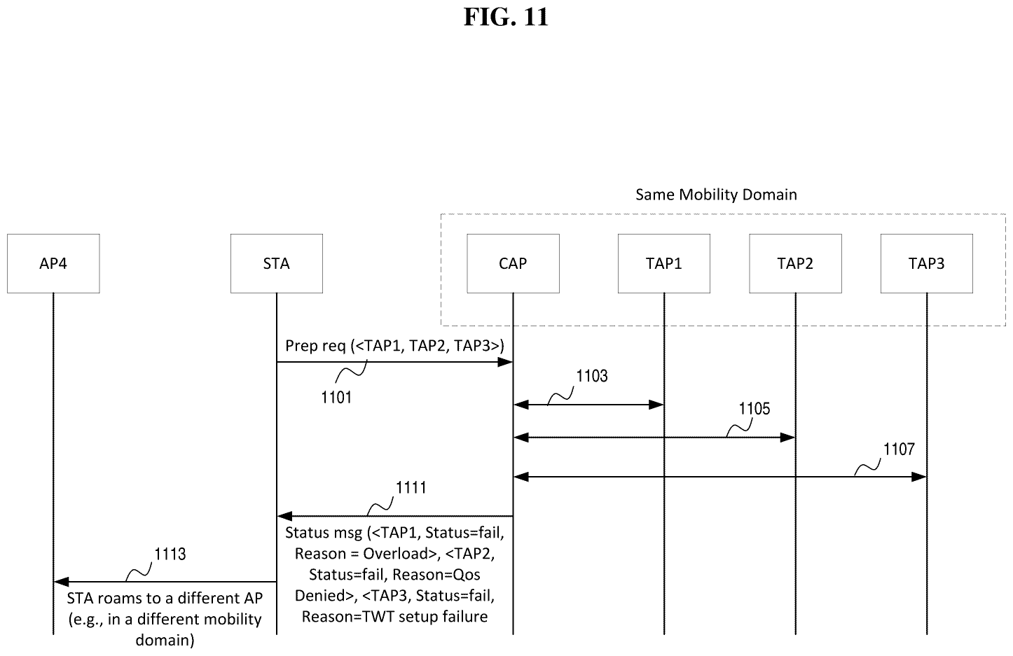

FIG. 11 illustrates an example timeline of a roaming preparation in accordance with an embodiment. In particular, FIG. 11 illustrates an STA and several APs, including current AP (CAP) with which the STA is associated, target APs including TAP1, TAP2, and TAP3. The CAP and TAP1, TAP2, and TAP3 are part of a same mobility domain. FIG. 11 also illustrates another AP, AP4, that is outside of the mobility domain. As illustrated, STA transmits a preparation request message 1101 to CAP, where the preparation request message indicates the target APs (TAP1, TAP2, and TAP3) that the STA intends to roam to. Accordingly, CAP communicates 1103 with TAP1 where the communication 1103 may include CAP1 transmitting a message to TAP1 that indicates STA intends to roam to TAP1 and receiving a response message from TAP1 that indicates whether TAP1 can accommodate the roaming request from the STA. Similarly, CAP communicates 1105 with TAP2 where the communication 1105 may include CAP1 transmitting a message to TAP2 that indicates STA intends to roam to TAP2 and receiving a response message from TAP2 that indicates whether TAP2 can accommodate the roaming request from the STA. Likewise, CAP communicates 1107 with TAP3 where the communication 1107 may include CAP1 transmitting a message to TAP3 that indicates STA intends to roam to TAP3 and receiving a response message from TAP3 that indicates whether TAP3 can accommodate the roaming request from the STA. Based on these communications 1103, 1105, and 1107, the CAP transmits to the STA a status message 1111 which indicates a status of the one or more target APs. In particular, the status message 111 indicates a failure with all the TAPs to accommodate the roaming request and the various reasons for the inability to accommodate the roaming request (e.g., TAP1, status=fail, reason=overload; TAP2, status=fail, reason=QoS denies; TAP3, status=fail, reason=TWT setup failures). Accordingly, STA roams 1113 to a different AP, AP4, that is in a different mobility domain. In some embodiments, the STA may roam to AP4 using baseline roaming procedures.

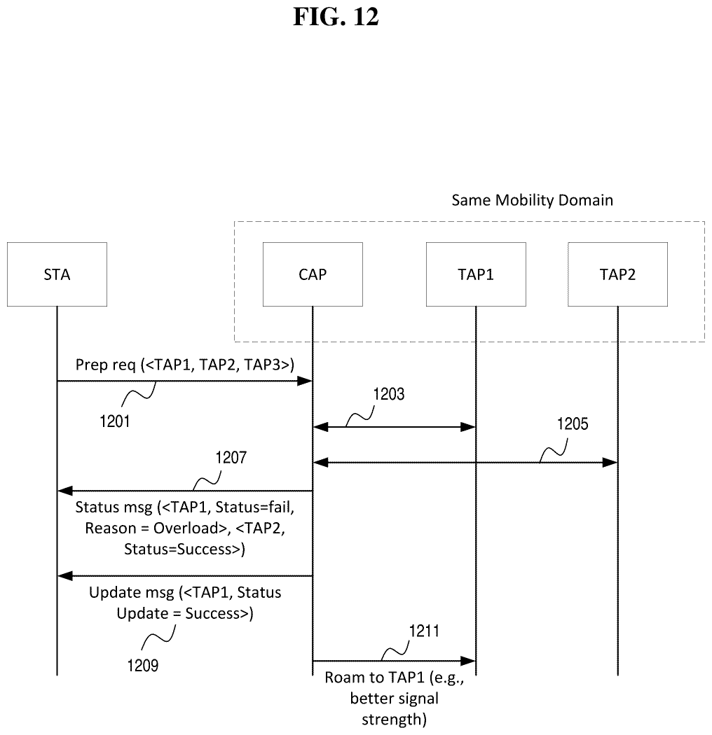

FIG. 12 illustrates an example timeline of a roaming preparation in accordance with an embodiment. In particular, FIG. 12 illustrates an STA and several APs, including current AP (CAP) with which the STA is associated, target APs including TAP1 and TAP2. The CAP, TAP1, and TAP2 are part of a same mobility domain.

As illustrated, STA transmits a preparation request message 1201 to CAP, where the preparation request message indicates the target APs (TAP1 and TAP2) that the STA intends to roam to. Accordingly, CAP communicates, 1203 and 1205 respectively, with TAP1 and TAP2 1205 to prepare the APs and determine whether the APs can accommodate the roaming request of the STA. In particular, CAP communicates 1203 with TAP1 where the communication 1203 may include CAP1 transmitting a message to TAP1 that indicates STA intends to roam to TAP1 and receiving a response message from TAP1 that indicates whether TAP1 can accommodate the roaming request from the STA. Similarly, CAP communicates 1205 with TAP2 where the communication 1205 may include CAP1 transmitting a message to TAP2 that indicates STA intends to roam to TAP2 and receiving a response message from TAP2 that indicates whether TAP2 can accommodate the roaming request from the STA. As illustrated, TAP2 can be prepared for roam but TAP cannot be prepared.

Accordingly, CAP transmits to the STA a status message 1207 indicating the TAP1 cannot be prepared along with a reason (e.g., TAP1, status=fail, reason=overload), and that TAP2 can be prepared (e.g., TAP2, status=success).

However, at a later point in time, TAP1 may also be prepared. Accordingly, CAP may transmit to the STA an update message 1209 that indicates that TAP may be prepared to accommodate a roaming (e.g., TAP1, status=success).

Upon receiving the update message 1209, the STA may determine to roam to TAP1 due to a variety of factors (e.g., better signal strength, among other factors).

Embodiments in accordance with this disclosure may be used for different roaming architectures, such as logical AP MLD, seamless mobility domain architecture, baseline architecture, among others.

Embodiments in accordance with this disclosure provide pre-roaming signaling procedures whereby a STA may transmit an intent to roam to one or more target APs to a current AP associated with the STA. Accordingly, the current AP may communicate with the one or more target APs to determine whether or not the target APs can accommodate the roam request and various traffic and QoS requirements of the STA, and the current AP can provide the status information to the STA such that once the STA determines a need to roam, it can successfully roam to target APs that are willing and able to accommodate the STAs roaming request, thereby minimizing failed roaming attempts. Accordingly, embodiments in accordance with this disclosure may perform a handover procedure, whereby low latency application traffic may get a necessary QoS treatment during roaming, providing an improved user experience especially with multimedia services which can suffer from session disruptions due to the high delay encountered during existing handover procedure.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory; and
a processor coupled to the memory, the processor configured to:
transmit, to an access point (AP) associated with the STA, a first frame indicating one or more target APs for an upcoming roaming, wherein the AP and the one or more target APs are in a first seamless mobility domain where the AP and the one or more target APs coordinate with one another;
receive, from the AP, a second frame including status information associated with the one or more target APs, the status information indicating whether the one or more target APs are prepared for the upcoming roaming; and
transition from the AP to a target AP based on the status information.

2. The STA of claim 1, wherein, to transition from the AP to the target AP, the processor is configured to:
determine that at least one target AP among the one or more target APs is prepared for the upcoming roaming based on the status information; and
transition from the AP to the at least one target AP among the one or more target APs.

3. The STA of claim 1, wherein, to transition from the AP to the target AP, the processor is configured to:
determine that no target AP among the one or more target APs is prepared for the upcoming roaming based on the status information; and
transition from the AP to the target AP (i) that is in a second seamless mobility domain (ii) that is in the first seamless mobility domain and is not among the one or more target APs, or (iii) that is not associated with a seamless mobility domain.

4. The STA of claim 1, wherein the processor is further configured to:
determine that no target AP among the one or more target APs is prepared for the upcoming roaming; and
transmit, to the AP, a third frame, wherein the third frame indicates one or more target APs for the upcoming roaming.

5. The STA of claim of claim 1, wherein the second frame includes one or more of: i) a list of one or more target APs that are prepared for the upcoming roaming, ii) a list of one or more target APs that are not prepared for the upcoming roaming, iii) a time period that the STA has to wait before performing another roaming attempt or iv) one or more status codes providing status information for the one or more target APs regarding the upcoming roaming.

6. The STA of claim 1, wherein the second frame indicates a time deadline for the STA to transition to the target AP.

7. The STA of claim 1, wherein the processor is further configured to:
receive, from the AP, a third frame that includes update status information associated with the one or more target APs; and
determine whether to roam to a target AP from the one or more target APs based on the updated status information.

8. An access point (AP) in a wireless network, the AP comprising:
a memory; and
a processor coupled to the memory, the processor configured to:
receive, from a station (STA) associated with AP, a first frame indicating one or more target APs for an upcoming roaming, wherein the AP and the one or more target APs are in a first seamless mobility domain where the AP and the one or more target APs coordinate with one another; and
transmit, to the STA, a second frame including status information associated with the one or more target APs, the status information indicating whether the one or more target APs are prepared for the upcoming roaming.

9. The AP of claim 8, wherein at least one target AP among the one or more target APs is prepared for the upcoming roaming based on the status information, wherein the processor is configured to:
communicate with the at least one target AP among the one or more target APs to transition the STA from the AP to the at least one target AP.

10. The AP of claim 8, wherein no target AP among the one or more target APs is prepared for the upcoming roaming, wherein the processor is configured to:
receive, from the STA, a third frame, wherein the third frame indicates one or more target APs for the upcoming roaming.

11. The AP of claim of claim 8, wherein the second frame includes one or more of: i) a list of one or more target APs that are prepared for the upcoming roaming, ii) a list of one or more target APs that are not prepared for the upcoming roaming, iii) a time period that the STA has to wait before performing another roaming attempt or iv) more status codes providing status information for the one or more target APs regarding the upcoming roaming.

12. The AP of claim 8, wherein the second frame indicates a time deadline for the STA to transition to the target AP.

13. The AP of claim 8, wherein the processor is further configured to:
transmit, to the STA, a third frame that includes update status information associated with the one or more target APs.

14. A computer-implemented method for communication by a station (STA) in a wireless network, comprising:
transmitting, to an access point (AP) associated with the STA, a first frame indicating one or more target APs for an upcoming roaming, wherein the AP and the one or more target APs are in a first seamless mobility domain where the AP and the one or more target APs coordinate with one another;
receiving, from the AP, a second frame including status information associated with the one or more target APs, the status information indicating whether the one or more target APs are prepared for the upcoming roaming; and
transitioning from the AP to a target AP based on the status information.

15. The computer-implemented method of claim 14, further comprising, to transition from the AP to the target AP:
determining that at least one target AP among the one or more target APs is prepared for the upcoming roaming based on the status information; and
transitioning from the AP to the at least one target AP among the one or more target APs.

16. The computer-implemented method of claim 14, further comprising, to transition from the AP to the target AP:
determining that no target AP among the one or more target APs is prepared for the upcoming roaming based on the status information; and
transitioning from the AP to the target AP (i) that is in a second seamless mobility domain (ii) that is in the first seamless mobility domain and is not in the one or more target APs, or (iii) that is not associated with a seamless mobility domain.

17. The computer-implemented method of claim 14, further comprising:
determining that no target AP among the one or more target APs is prepared for the upcoming roaming; and
transmitting, to the AP, a third frame, wherein the third frame indicates one or more target APs for the upcoming roaming.

18. The computer-implemented method of claim 14, wherein the second frame includes one or more of: i) a list of one or more target APs that are prepared for the upcoming roaming, ii) a list of one or more target APs that are not prepared for the upcoming roaming, iii) a time period that the STA has to wait before performing another roaming attempt or iv) one or more status codes providing status information for the one or more target APs regarding the upcoming roaming.

19. The computer-implemented method of claim 14, wherein the second frame indicates a time deadline for the STA to transition to the target AP.

20. The computer-implemented method of claim 14, further comprising:
receiving, from the AP, a third frame that includes update status information associated with the one or more target APs; and
determining whether to roam to a target AP from the one or more target APs based on the updated status information.
